(19) United States
(12) Patent Application Publication
(10) Pub. No.: US 2025/0307711 A1
(43) Pub. Date: Oct. 2, 2025

(54) SYSTEM AND METHOD FOR DATA SEGMENTATION AND MANAGEMENT

(71) Applicant: Kinaxis Inc., Ottawa (CA)

(72) Inventors: Yousra Mohamed, Mississauga (CA); Sudhan Mani, Channai (IN); Sagnik Som, Toronto (CA)

(73) Assignee: Kinaxis Inc., Ottawa (CA)

(21) Appl. No.: 19/095,130

(22) Filed: Mar. 31, 2025

Related U.S. Application Data
(60) Provisional application No. 63/654,449, filed on May 31, 2024.

(30) Foreign Application Priority Data
Mar. 29, 2024 (IN) 202411026061

(51) Int. Cl. G06N 20/00; G06F 16/901

(52) U.S. Cl. CPC G06N 20/00; G06F 16/9014

(57) ABSTRACT

A system and method are provided relating to segmentation of data sets. A processor may be configured to generate, for each of a plurality of data segments in first and second segmentation runs, a content-based segment identifier. The processor may be configured to identify, by the processor, a set of modified data segments between a first segmentation run and a second segmentation run by comparing the content-based segment identifiers for the first plurality of data segments with the content-based segment identifiers for the second plurality of data segments. The processor may be configured to incrementally train the machine learning model for only the set of modified data segments.

### CROSS REFERENCE TO RELATED APPLICATIONS

The present application claims the benefit of U.S. Provisional Patent Application No. 63/654,449 filed May 31, 2024; and Indian Patent Application number 202411026061 filed Mar. 29, 2024, each of which is expressly incorporated herein by reference in its respective entirety herein.

### BACKGROUND

Segmentation is a methodology employed to partition a dataset into distinct segments. This process involves utilizing a segmentation algorithm or method, which is accompanied by a set of features known as segment keys and a specified segment size that determines the number of rows each segment should encompass. For example, segmentation keys may use attributes like brand or store location to segment or split data, for example relating to product inventory.

A segmentation method initiates by grouping the data based on the first segment key, and subsequently, the size of each segment is evaluated. If a segment's size exceeds the desired row count, further segmentation occurs using the next segment key, continuing until the desired size is achieved. Conversely, if the grouping results in segments smaller than the desired row count, the algorithm consolidates a subset of these groups into a single segment to approximate the target row count. Consequently, the segmentation algorithm efficiently divides the input dataset into roughly equal-sized segments, assigning each a universally unique identifier (UUID).

These segmented datasets may serve as a foundation for generating a sequence of machine learning artifacts, subsequently employed in making forecasts. When the dataset is refreshed with new data, the segmentation algorithm must be rerun, producing a new set of segments.

Despite incremental data refreshes typically affecting a small dataset subset, the segmentation method's nature generates a new segment set with newly assigned UUIDs. Consequently, all associated artifacts need to be regenerated in response to this segmentation update.

### BRIEF SUMMARY

The details of one or more embodiments of the subject matter of this specification are set forth in the accompanying drawings and the description below. Other features, aspects, and advantages of the subject matter may become apparent from the description, the drawings, and the claims.

In one aspect, a system is provided, that includes a processor. The system also includes a memory storing instructions that, when executed by the processor, configure the system to: generate, in relation to a first segmentation run for a first plurality of data segments, a first set of content-based segment identifiers based on unique content-based attributes of the first plurality of data segments; initially train a machine learning model based on the first plurality of data segments; generate, in relation to a second segmentation run for a second plurality of data segments, a second set of content-based segment identifiers based on second content-based attributes of the second plurality of data segments; identify a set of modified data segments between the first segmentation run and the second segmentation run by comparing the content-based segment identifiers for the first plurality of data segments with the content-based segment identifiers for the second plurality of data segments; and incrementally train the machine learning model for only the set of modified data segments.

In an embodiment of the system, the unique content-based attributes may include a unique sequence of segment key and value combinations. In an embodiment of the system, the unique content-based attributes may include a unique sequence of segment key and value pairs. In an embodiment, the system may be further configured to: generate a first hash of the unique content-based attributes associated with the first set of content-based segment identifiers when generating the first set of content-based segment identifiers; and generate a second hash of the unique content-based attributes associated with the second set of content-based segment identifiers when generating the second set of content-based segment identifiers. In an embodiment of the system, each of the first set of content-based segment identifiers and the second set of content-based segment identifiers may include a universally unique content-based segment identifier. Other technical features may be readily apparent to one skilled in the art from the following figures, descriptions, and claims.

In one aspect, a system is provided, that includes a processor. The system also includes a memory storing instructions that, when executed by the processor, configure the system to: generate, during a first segmentation run for a first plurality of data segments, a first set of content-based segment identifiers based on unique content-based attributes of the first plurality of data segments; generate, during a second segmentation run for a second plurality of data segments, a second set of content-based segment identifiers based on unique content-based attributes of the second plurality of data segments; identify unchanged data segments between the first segmentation run and the second segmentation run by comparing the content-based segment identifiers for the first plurality of data segments with the content-based segment identifiers for the second plurality of data segments; and generate and store a list of unchanged data segments to omit from incremental training of a machine learning model. Other technical features may be readily apparent to one skilled in the art from the following figures, descriptions, and claims.

In one aspect, a system is provided, that includes a processor. The system also includes a memory storing instructions that, when executed by the processor, configure the system to: obtain, during a first segmentation run, a first plurality of data segments each includes unique content-based attributes; generate, in relation to the first segmentation run, a content-based segment identifier for each of the first plurality of data segments based on the unique content-based attributes; obtain, in relation to a second segmentation run, a second plurality of data segments each includes second content-based attributes; generate, in relation to the second segmentation run, a content-based segment identifier for each of the second plurality of data segments based on the second content-based attributes; and store modified data segment identifiers associated with a set of modified data segments based on a comparison of the content-based segment identifiers for the first plurality of data segments with the content-based segment identifiers for the second plurality of data segments. Other technical features may be readily apparent to one skilled in the art from the following figures, descriptions, and claims.

In an embodiment, the system may be further configured to: identify the set of modified data segments by comparing the content-based segment identifiers for the first plurality of data segments with the content-based segment identifiers for the second plurality of data segments. Other technical features may be readily apparent to one skilled in the art from the following figures, descriptions, and claims.

In one aspect, a system is provided, that includes a processor. The system also includes a memory storing instructions that, when executed by the processor, configure the system to: obtain a plurality of data segments, each of the plurality of data segments includes unique content-based attributes; and generate, for each of the plurality of data segments, a content-based segment identifier based on the unique content-based attributes.

In an embodiment of the system, the unique content-based attributes may include a unique sequence of segment key and value combinations. In an embodiment of the system, the unique content-based attributes may include a unique sequence of segment key and value pairs. In an embodiment of the system, the system may be further configured to generate a hash of the unique content-based attributes when generating the content-based segment identifier. In an embodiment of the system, the content-based segment identifier may include a universally unique content-based segment identifier. Other technical features may be readily apparent to one skilled in the art from the following figures, descriptions, and claims.

In one aspect, a non-transitory computer-readable storage medium is provided. The computer-readable storage medium includes instructions that when executed by a computer, cause the computer to: generate, in relation to a first segmentation run for a first plurality of data segments, a first set of content-based segment identifiers based on unique content-based attributes of the first plurality of data segments; initially train a machine learning model based on the first plurality of data segments; generate, in relation to a second segmentation run for a second plurality of data segments, a second set of content-based segment identifiers based on second content-based attributes of the second plurality of data segments; identify a set of modified data segments between the first segmentation run and the second segmentation run by comparing the content-based segment identifiers for the first plurality of data segments with the content-based segment identifiers for the second plurality of data segments; and incrementally train the machine learning model for only the set of modified data segments.

In an embodiment of the non-transitory computer-readable storage medium, the unique content-based attributes may include a unique sequence of segment key and value combinations. In an embodiment of the non-transitory computer-readable storage medium, the unique content-based attributes may include a unique sequence of segment key and value pairs. In an embodiment of the non-transitory computer-readable storage medium, the computer may be further configured to: generate a first hash of the unique content-based attributes associated with the first set of content-based segment identifiers when generating the first set of content-based segment identifiers including; and generate a second hash of the unique content-based attributes associated with the second set of content-based segment identifiers when generating the second set of content-based segment identifiers. In an embodiment of the non-transitory computer-readable storage medium, each of the first set of content-based segment identifiers and the second set of content-based segment identifiers may include a universally unique content-based segment identifier. Other technical features may be readily apparent to one skilled in the art from the following figures, descriptions, and claims.

In one aspect, a non-transitory computer-readable storage medium is provided, the non-transitory computer-readable storage medium including instructions that when executed by a computer, cause the computer to: generate, during a first segmentation run for a first plurality of data segments, a first set of content-based segment identifiers based on unique content-based attributes of the first plurality of data segments; generate, during a second segmentation run for a second plurality of data segments, a second set of content-based segment identifiers based on unique content-based attributes of the second plurality of data segments; identify unchanged data segments between the first segmentation run and the second segmentation run by comparing the content-based segment identifiers for the first plurality of data segments with the content-based segment identifiers for the second plurality of data segments; and generate and store a list of unchanged data segments to omit from incremental training of a machine learning model. Other technical features may be readily apparent to one skilled in the art from the following figures, descriptions, and claims.

In one aspect, a non-transitory computer-readable storage medium is provided, the non-transitory computer-readable storage medium including instructions that when executed by a computer, cause the computer to: obtain, during a first segmentation run, a first plurality of data segments each includes unique content-based attributes; generate, in relation to the first segmentation run, a content-based segment identifier for each of the first plurality of data segments based on the unique content-based attributes; obtain, in relation to a second segmentation run, a second plurality of data segments each includes second content-based attributes; generate in relation to the second segmentation run, a content-based segment identifier for each of the second plurality of data segments based on the second content-based attributes; and store modified data segment identifiers associated with a set of modified data segments based on a comparison of the content-based segment identifiers for the first plurality of data segments with the content-based segment identifiers for the second plurality of data segments.

In an embodiment, the non-transitory computer-readable storage medium can further include instructions that, when executed by the computer, cause the computer to: identify the set of modified data segments by comparing the content-based segment identifiers for the first plurality of data segments with the content-based segment identifiers for the second plurality of data segments. Other technical features may be readily apparent to one skilled in the art from the following figures, descriptions, and claims.

In one aspect, a non-transitory computer-readable storage medium is provided. The non-transitory computer-readable storage medium includes instructions that when executed by a computer, cause the computer to: obtain a plurality of data segments, each of the plurality of data segments includes unique content-based attributes; and generate for each of the plurality of data segments, a content-based segment identifier based on the unique content-based attributes.

In an embodiment of the non-transitory computer-readable storage medium, the unique content-based attributes may include a unique sequence of segment key and value combinations. In an embodiment of the non-transitory computer-readable storage medium, the unique content-based attributes may include a unique sequence of segment key and value pairs. In an embodiment of the non-transitory computer-readable storage medium, the computer may be further configured to generate a hash of the unique content-based attributes when generating the content-based segment identifier. In an embodiment of the non-transitory computer-readable storage medium, the content-based segment identifier includes a universally unique content-based segment identifier. Other technical features may be readily apparent to one skilled in the art from the following figures, descriptions, and claims.

In one aspect, a method of training a machine learning model in a data segmentation environment in provided, that includes: generating, by a processor and in relation to a first segmentation run for a first plurality of data segments, a first set of content-based segment identifiers based on unique content-based attributes of the first plurality of data segments; initially training the machine learning model based on the first plurality of data segments; generating, by a processor and in relation to a second segmentation run for a second plurality of data segments, a second set of content-based segment identifiers based on second content-based attributes of the second plurality of data segments; identifying, by the processor, a set of modified data segments between the first segmentation run and the second segmentation run by comparing the content-based segment identifiers for the first plurality of data segments with the content-based segment identifiers for the second plurality of data segments; and incrementally training the machine learning model for only the set of modified data segments.

In an embodiment of the method, the unique content-based attributes may include a unique sequence of segment key and value combinations. In an embodiment of the method, the unique content-based attributes may include a unique sequence of segment key and value pairs. In an embodiment of the method, generating the first set of content-based segment identifiers may include: generating, by the processor, a first hash of the unique content-based attributes associated with the first set of content-based segment identifiers; and generating, by the processor the second set of content-based segment identifiers may include generating a second hash of the unique content-based attributes associated with the second set of content-based segment identifiers. In an embodiment of the method, each of the first set of content-based segment identifiers and the second set of content-based segment identifiers may include a universally unique content-based segment identifier. Other technical features may be readily apparent to one skilled in the art from the following figures, descriptions, and claims.

In one aspect, a method of data segment identification is provided, that includes: generating, by a processor and during a first segmentation run for a first plurality of data segments, a first set of content-based segment identifiers based on unique content-based attributes of the first plurality of data segments; generating, by a processor and during a second segmentation run for a second plurality of data segments, a second set of content-based segment identifiers based on unique content-based attributes of the second plurality of data segments; identifying, by the processor, unchanged data segments between the first segmentation run and the second segmentation run by comparing the content-based segment identifiers for the first plurality of data segments with the content-based segment identifiers for the second plurality of data segments; and generating and storing a list of unchanged data segments to omit from incremental training of a machine learning model. Other technical features may be readily apparent to one skilled in the art from the following figures, descriptions, and claims.

In one aspect, a method of data tracing in a data segmentation environment is provided, that includes: obtaining, by a processor and during a first segmentation run, a first plurality of data segments each includes unique content-based attributes; generating, by the processor and in relation to the first segmentation run, a content-based segment identifier for each of the first plurality of data segments based on the unique content-based attributes; obtaining, by the processor and in relation to a second segmentation run, a second plurality of data segments each includes second content-based attributes; generating, by the processor and in relation to the second segmentation run, a content-based segment identifier for each of the second plurality of data segments based on the second content-based attributes; and storing, by the processor, modified data segment identifiers associated with a set of modified data segments based on a comparison of the content-based segment identifiers for the first plurality of data segments with the content-based segment identifiers for the second plurality of data segments.

The method may also further include: identifying, by the processor, the set of modified data segments by comparing the content-based segment identifiers for the first plurality of data segments with the content-based segment identifiers for the second plurality of data segments. Other technical features may be readily apparent to one skilled in the art from the following figures, descriptions, and claims.

In one aspect, a method of data segment identifier generation is provided, that includes: obtaining, by a processor, a plurality of data segments, each of the plurality of data segments includes unique content-based attributes; and generating, by the processor and for each of the plurality of data segments, a content-based segment identifier based on the unique content-based attributes.

In an embodiment of the method, the unique content-based attributes may include a unique sequence of segment key and value combinations. In an embodiment of the method, the unique content-based attributes may include a unique sequence of segment key and value pairs. In an embodiment of the method, generating the content-based segment identifier may include generating a hash of the unique content-based attributes. In an embodiment of the method, the content-based segment identifier may include a universally unique content-based segment identifier. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example block diagram of a system for data tracing in a data segmentation environment in accordance with one embodiment.

FIG. 2 illustrates a routine in accordance with one embodiment.

FIG. 3 illustrates an aspect of the subject matter showing a first relationship between segment keys and values in accordance with one embodiment.

FIG. 4 illustrates an aspect of the subject matter showing implementation of a segmentation method including a plurality of segmentation runs in accordance with one embodiment.

FIG. 5 illustrates an aspect of the subject matter showing segment identifier outputs based on execution of the segmentation runs of FIG. 4 in accordance with one embodiment.

FIG. 6 illustrates an aspect of the subject matter showing a second relationship between segment keys and values in accordance with one embodiment.

FIG. 7 illustrates an aspect of the subject matter showing implementation of a segmentation method including a plurality of segmentation runs in accordance with one embodiment.

FIG. 8 illustrates an aspect of the subject matter showing segment identifier outputs based on execution of the method of FIG. 7 in accordance with one embodiment.

FIG. 9 illustrates a routine in accordance with one embodiment.

FIG. 10 illustrates a routine in accordance with one embodiment.

FIG. 11 illustrates a routine in accordance with one embodiment.

### DETAILED DESCRIPTION

A system and method are provided relating to segmentation of data sets. A processor may be configured to generate, for each of a plurality of data segments in first and second segmentation runs, a content-based segment identifier. The processor may be configured to identify, by the processor, a set of modified data segments between a first segmentation run and a second segmentation run by comparing the content-based segment identifiers for the first plurality of data segments with the content-based segment identifiers for the second plurality of data segments. The processor may be configured to incrementally train the machine learning model for only the set of modified data segments.

Known approaches generate and assign a UUID to each segment, which has a disadvantage of assigning a unique identifier every time segmentation is performed, even if some of the underlying data is unchanged. Embodiments of the present disclosure generate a content-based segment identifier, such that the identifier is unique for a set of content, also referred to as the tenants of the segments. Since the segment identifier is content-based, a processor may be configured to compare the content-based segment identifiers from each of a plurality of segmentation runs to determine which content has changed, and which content has stayed the same. In addition to providing advantages for segmentation and segment identification, this can advantageously be used for selective training of a machine learning model for only the set of modified data segments, as identified based on changes in underlying content, since a content-based segment identifier is used.

Embodiments of the present disclosure provide advantages of cost optimization in terms of processing time and memory use, for example by selectively training or incrementally training a machine learning model only for changed data, as opposed to known approaches that incrementally train based on all data from a new segmentation run. This provides an improvement in the functioning of a computer, and provides a useful and tangible result.

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

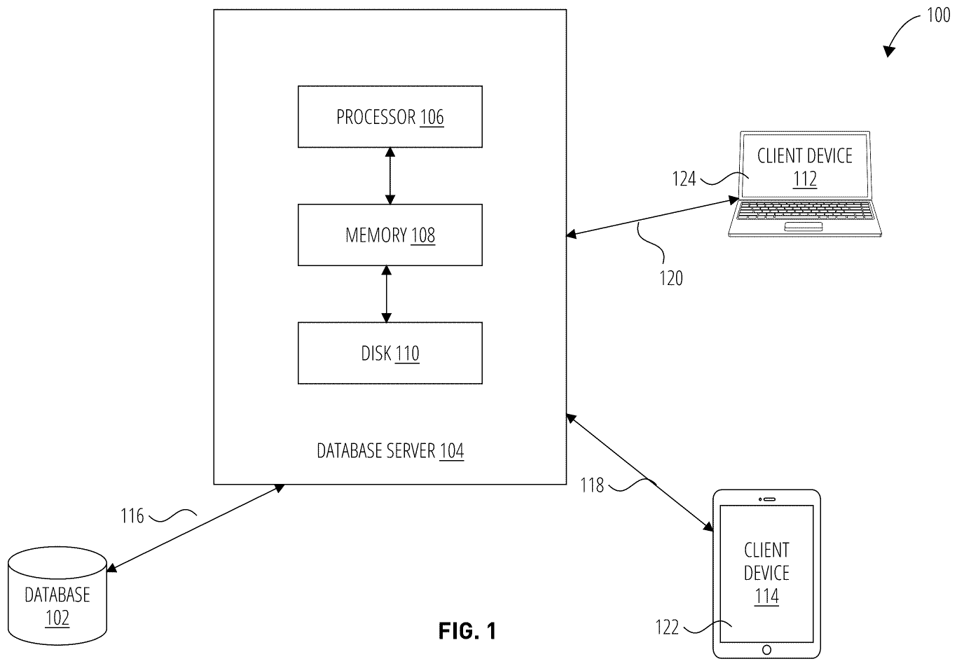

FIG. 1 illustrates an example of a system 100 for data tracing in a data segmentation environment in accordance with one embodiment.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

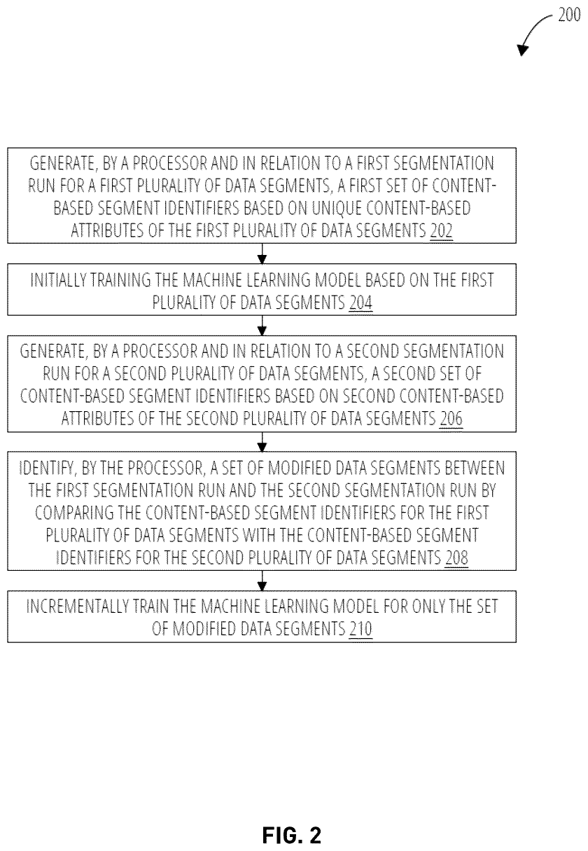

FIG. 2 is a flowchart illustrating a method of training a machine learning model in a data segmentation environment illustrates in accordance with one embodiment. FIG. 2 illustrates a routine 200 in accordance with one embodiment. In block 202, routine 200 generates, by a processor and in relation to a first segmentation run for a first plurality of data segments, a first set of content-based segment identifiers based on unique content-based attributes of the first plurality of data segments. The first set of content-based segment identifiers is based on the content of the first plurality of data segments, in contrast to known approaches that generate a universally unique identifier (UUID) that is unrelated to the content of the data segment. In block 204, routine 200 initially trains the machine learning model based on the first plurality of data segments.

In block 206, routine 200 generates, by a processor and in relation to a second segmentation run for a second plurality of data segments, a second set of content-based segment identifiers based on second content-based attributes of the second plurality of data segments. In block 208, routine 200 identifies, by the processor, a set of modified data segments between the first segmentation run and the second segmentation run. The set of modified data segments may be identified by comparing the content-based segment identifiers for the first plurality of data segments with the content-based segment identifiers for the second plurality of data segments. When the content-based segment identifiers match between the first segmentation run and the second segmentation run, this is an indication that the content in that segment has not changed, and that segment may be omitted from incremental training of the machine learning model. In block 210, routine 200 incrementally trains, by the processor, the machine learning model for only the set of modified data segments.

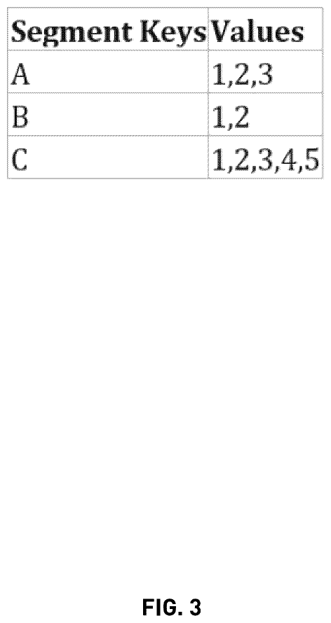

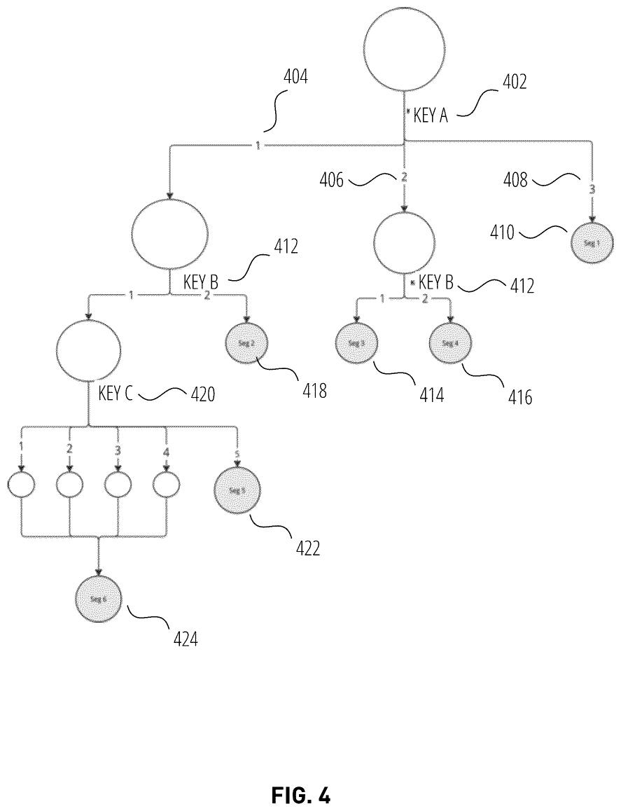

FIG. 3 illustrates an aspect of the subject matter showing a first relationship between segment keys and values in accordance with one embodiment. In the chart shown in FIG. 3: segment key A is shown as having possible values of 1, 2 and 3; segment key B is shown as having possible values of 1 and 2; and segment key C is shown as having possible values of 1, 2, 3, 4 and 5. These segment keys and values are used in relation to the segmentation run shown in FIG. 4.

The segment keys in FIG. 3 are referred to generically using keys A, B and C, but may relate to any type or property or attribute associated with the data, such as store location, product code, product model, brand, etc. So, if segment key A referred to brand and segment key B referred to store location, the segment keys may be used together to determine how many Nike shoes are at a store in Vancouver, or how many Puma shoes are at a store in Milwaukee.

FIG. 4 illustrates an aspect of the subject matter showing implementation of a segmentation method including a plurality of segmentation runs in accordance with one embodiment. As shown in FIG. 4, a segment key A 402 is used to segment an initial data set into values 1, 2 and 3 (404, 406 and 408, respectively). The results for value 3 (408) for segment key A 402 are a small enough data set that no further segmentation is required in that branch. This defines segment 1 (410), based on A=3. The determination of whether a data set is small or large enough may be performed in relation to a stored data threshold.

Segmentation key B 412 is used to further segment the results of values 1 and 2 from segment key A 402. Applying segmentation key B 412 to the results of value 2 from segment key A 404 produces two values 1 and 2, the results of which are each a small enough data set that no further segmentation is required in that branch. This defines segment 3 (414) as A=2, B=1 and segment 4 (416) as A=2, B=2.

Applying segmentation key B to the results of value 1 from segment key A 402 produces two values 1 and 2. The results from value 2 are a small enough data set that no further segmentation is required in that branch. This defines segment 2 (418) as A=1, B=2. The results from value 1 are large enough to require further segmentation.

Segmentation key C 420 is applied to the results for value of 1 from segmentation key B 412. In this case, the results of value 5 from segmentation key C 420 are a small enough data set so that no further segmentation is required from that branch. This defines segment 5 (422) as A=1, B=2, C=5. The results of values 1, 2, 3 and 4 are small enough that they are combined or amalgamated into a single data set defining segment 6 (424) as A=1, B=1, CE {1,2,3,4}.

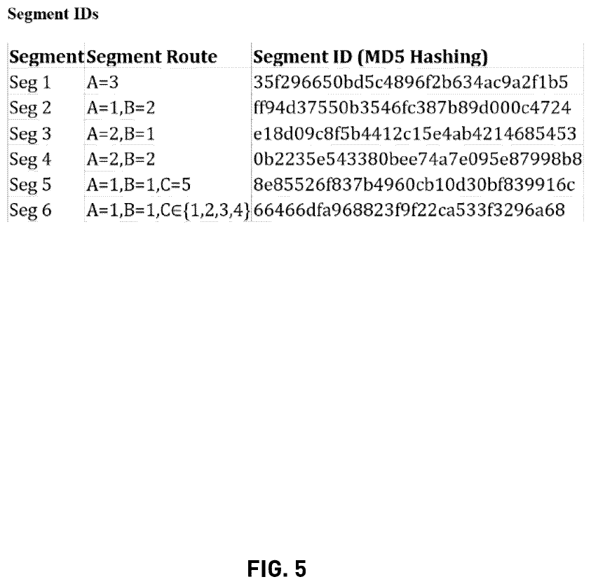

FIG. 5 illustrates an aspect of the subject matter showing segment identifier outputs based on execution of the segmentation runs of FIG. 4 in accordance with one embodiment. The output shown in FIG. 5 shows each segment number associated with its corresponding segment route, as described in relation to FIG. 4. For each unique segment, a content-based segment identifier is generated based on unique content-based attributes of each data segment. For example, for segment 1 (410 in FIG. 4), the method generates a unique content-based segment identifier, for example by applying a hash such as MD5 hashing to the content of A=3, to generate the unique content-based identifier 35f296650bd5c4896f2b634ac9a2f1b5. Any number of hashing algorithms may be used to generate a unique content-based segment identifier, such as MD5 (Message-Digest), SHA (Secure Hash Algorithm) or similar hash functions. The size of the hash may be selected to avoid collisions, such as using a bigger hash such as 256 to avoid collisions. Similar example unique content-based segment identifiers are generated for each of segments 2, 3, 4, 5 and 6 based on their respective unique content-based attributes, for example the values associated with each of the segment keys for that segment route.

In one aspect, associated with the implementation of FIG. 5, the following steps or actions are implemented: generating, by a processor and in relation to a first segmentation run for a first plurality of data segments, a first set of content-based segment identifiers based on unique content-based attributes of the first plurality of data segments, initially training the machine learning model based on the first plurality of data segments.

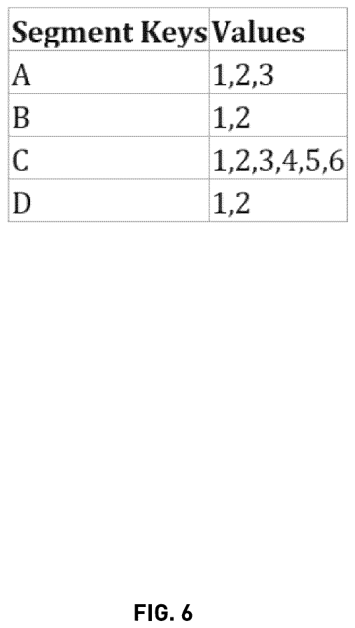

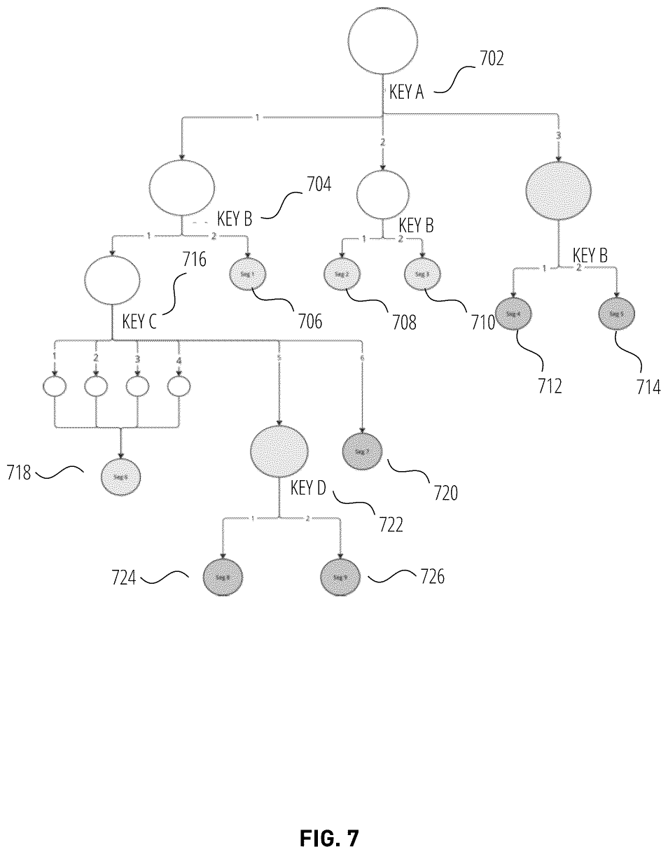

FIG. 6 illustrates an aspect of the subject matter showing a second relationship between segment keys and values in accordance with one embodiment. In the chart shown in FIG. 6: segment key A is shown as having possible values of 1, 2 and 3; segment key B is shown as having possible values of 1 and 2; and segment key C is shown as having possible values of 1, 2, 3, 4, 5 and 6; and segment key D is shown as having possible values of 1 and 2. These segment keys and values are used in relation to the segmentation run shown in FIG. 7.

FIG. 7 illustrates an aspect of the subject matter showing implementation of a segmentation method including a plurality of segmentation runs in accordance with one embodiment. As shown in FIG. 7, a segment key A 702 is used to segment an initial data set into values 1, 2 and 3. Since none of the data sets is small enough, segment key B 704 is applied to all of the outputs. This is in contrast to the first segmentation run in FIG. 4, in which the results for value 3 for segment key A (402 in FIG. 4) had been small enough data set that no further segmentation was required in that branch.

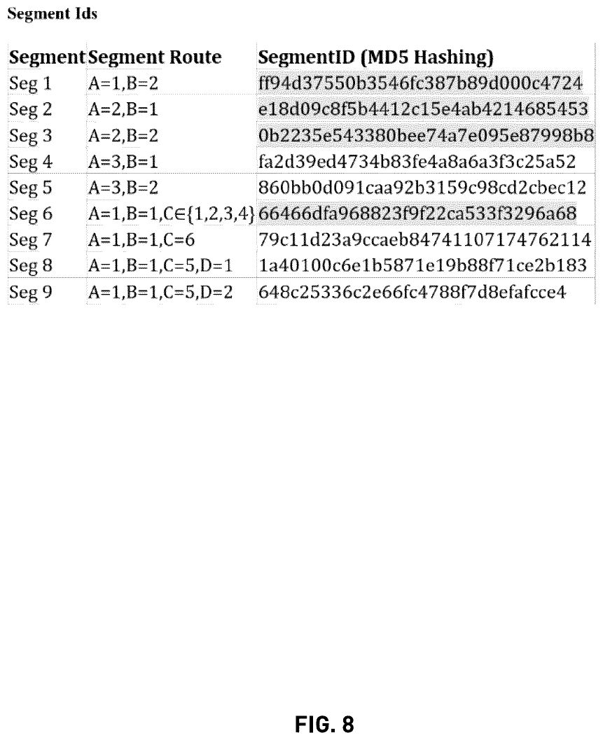

Segmentation key B 704 is used to further segment the results of values 1, 2 and 3 from segment key A 702. Applying segmentation key B 704 to the results of value 1 from segment key A 702 produces two values 1 and 2. The results from value 2 are a small enough data set that no further segmentation is required in that branch. This defines segment 1 (706) as A=1, B=2. Segment 1 (706) from FIG. 7 has the same content as segment 2 (418) from FIG. 4. Using embodiments of the present disclosure, this corresponding relationship is observable, and will be described further in relation to FIG. 8, in contrast to known approaches which are not able to observe this relationship.

Applying segmentation key B 704 to the results of value 2 from segment key A 702 produces two values 1 and 2, the results of which are each a small enough data set that no further segmentation is required in that branch. This defines segment 2 (712) as A=2, B=1 and segment 3 (714) as A=2, B=2. Segments 2 (708) and 3 (710) of FIG. 7 have the same content as segments 3 (414) and 4 (416) of FIG. 4.

Applying segmentation key B 704 to the results of value 3 from segment key A 702 produces two values 1 and 2, the results of which are each a small enough data set that no further segmentation is required in that branch. This defines segment 4 (712) as A=3, B=1 and segment 5 (714) as A=3, B=2. These segments 4 (712) and 5 (714) from FIG. 7 are different from the segments in FIG. 4, since segment key B (412 in FIG. 4) was not applied to the A=3 output in FIG. 4.

Segmentation key C 716 is applied to the results for value of 1 from segmentation key B 704. In this case, the results of value 6 from segmentation key C 716 are a small enough data set so that no further segmentation is required from that branch. This defines segment 7 (720) as A=1, B=2, C=6. The results of values 1, 2, 3 and 4 are small enough that they are amalgamated into a single data set defining segment 6 (718) as A=1, B=1, CE {1,2,3,4}. Segment 6 (718) in FIG. 7 has the same content as segment 6 (424) from FIG. 4.

As shown in FIG. 7, the results from value 5 from segmentation key C 716 are large enough that they require further segmentation. Segmentation key D 722 is applied to those results, and those sets of results are small enough not to require any further segmentation. Therefore, the following segments are defined: segment 8 (724) based on A=1, B=1, C=5, D=1; and segment 9 (726) based on A=1, B=1, C=5, D=2.

FIG. 8 illustrates an aspect of the subject matter showing segment identifier outputs based on execution of the method of FIG. 7 in accordance with one embodiment. Similar to FIG. 5, the chart of FIG. 8 shows content-based segment identifiers for each of the segments, where the content-based segment identifiers are generated based on unique content-based attributes of each of the segments. Because the segment identifiers are content-based, if the content is unchanged from the first segmentation run associated with FIG. 4 to the second segmentation run associated with FIG. 7, the segment ID, or content-based segment identifier will also be unchanged. If the content has changed, the segment ID will also change.

The chart in FIG. 8 includes an indicator of which content-based segment identifiers of the second set of content-based segment identifiers are the same as content-based segment identifiers from the first sets of content-based segment identifiers. In the example embodiment of FIG. 8, this indicator is provided by highlighting content-based segment identifiers that are unchanged between the first segmentation run and the second segmentation run, even if their segment number (e.g. Segment 1) may have changed.

That is, Segment IDs for segments 1-3 and segment 6, shown in FIG. 8, remain unchanged from those for Segment IDs for segments 2-4 and segment 6 in FIG. 5. In FIG. 5, the ID of segment 2 with segment route A=1, B=2, is identical to the ID of segment 1 with the same segment route in FIG. 8. Similarly, in FIG. 5, the ID of segment 3 with segment route A=2, B=1, is identical to the ID of segment 2 with the same segment route in FIG. 8. Similarly, in FIG. 5, the ID of segment 4 with segment route A=2, B=2, is identical to the ID of segment 3 with the same segment route in FIG. 8. And finally, in FIG. 5, the ID of segment 6 with segment route A=1, B=1, CE {1,2,3,4}, is identical to the ID of segment 6 with the same segment route in FIG. 8.

In this way, embodiments of the present disclosure are configured to determine which of the content-based segment identifiers are the same, and omit those from any further training of the machine learning model. Embodiments of the present disclosure are configured to only perform incremental training of the machine leaning model for data sets associated with content-based segment identifiers that changed between the first segmentation run and the second segmentation run, or that are present in the second set of content-based segment identifiers and were absent from the first sets of content-based segment identifiers.

The highlighted segments (1-3 and 6) are those that were present in an earlier run, and for which the system may reuse existing artifacts and optimize based on that. The segments which are completely new are those for which the system must perform full training of the machine learning model, because they are new segments with new tenants. By comparing a previous artifact with a newly generated artifact, the system may compute how much data has changed from one segmentation run to another.

The system may compare results from different segmentation runs to use a machine learning model to predict certain types of sales. For example, a model may predict all Nike sales in LabCorp. Since embodiments of the present disclosure provide traceability, the system may determine for a certain time period, for example the last 3 months, that the model has predicted demand with 80% accuracy. If the system later determines that the model has been predicting demand with only 70% accuracy, embodiments of the present disclosure may be used to drill down across different segmentation runs to identify segments with the same content (e.g. All Nike sales in LabCorp), since the system generates content-based segment identifiers.

Accordingly, in one aspect, a method of training a machine learning model in a data segmentation environment includes, as described in relation to FIG. 4: generating, by a processor and in relation to a first segmentation run for a first plurality of data segments, a first set of content-based segment identifiers based on unique content-based attributes of the first plurality of data segments; and initially training the machine learning model based on the first plurality of data segments. The method may include, as described in relation to FIG. 7, generating, by a processor and in relation to a second segmentation run for a second plurality of data segments, a second set of content-based segment identifiers based on second content-based attributes of the second plurality of data segments; identifying, by the processor, a set of modified data segments between the first segmentation run and the second segmentation run by comparing the content-based segment identifiers for the first plurality of data segments with the content-based segment identifiers for the second plurality of data segments; and incrementally training the machine learning model for only the set of modified data segments.

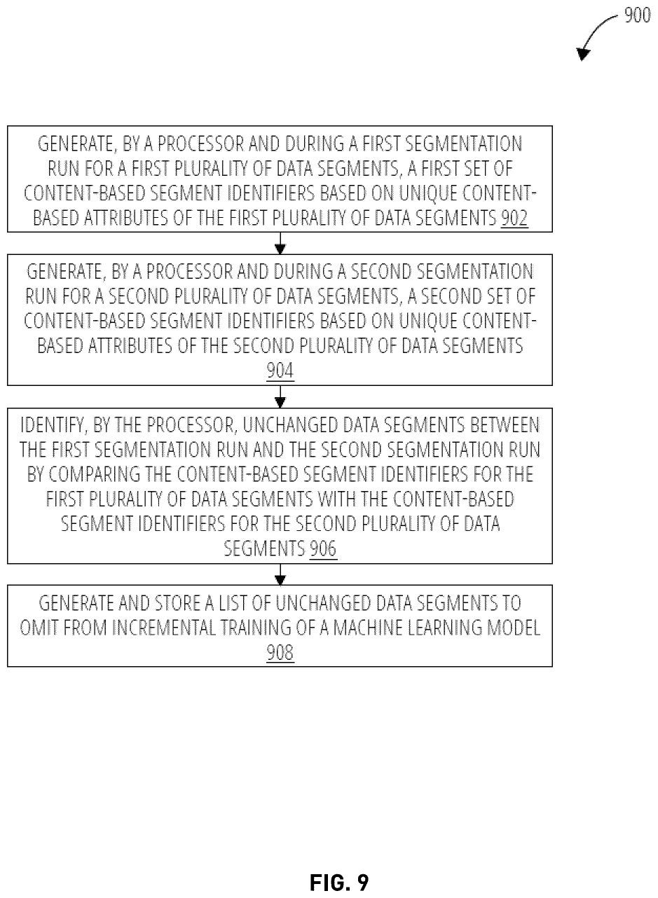

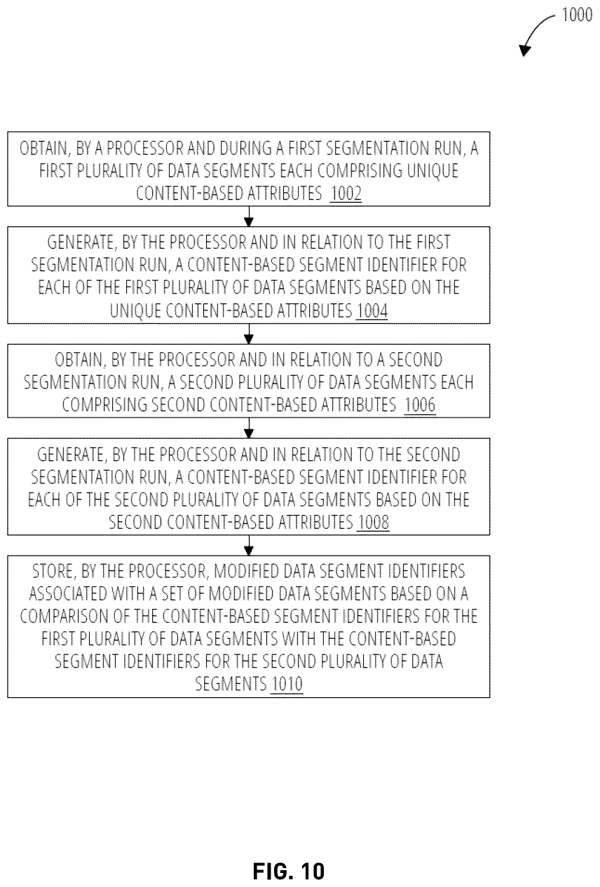

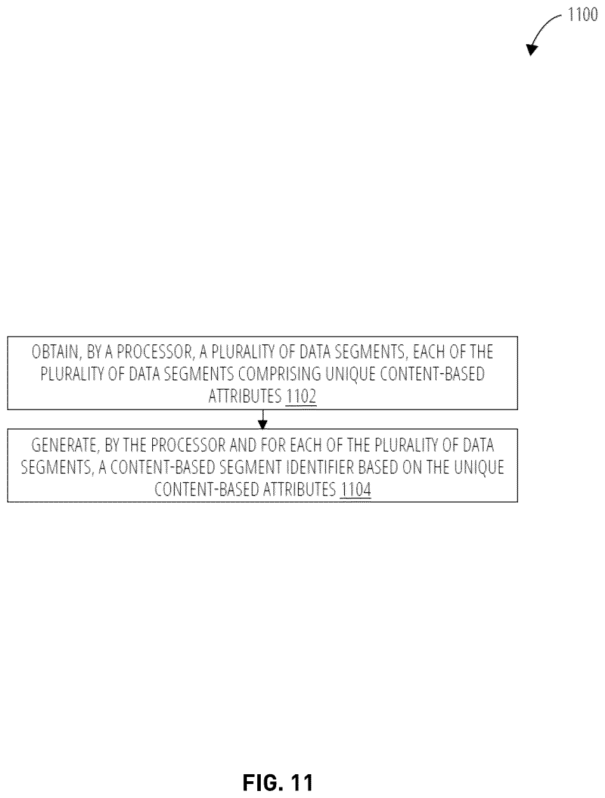

According to the present disclosure, other embodiments for implementing segmentation and/or machine learning training solutions are provided. Such embodiments will now be described in relation to FIG. 9, FIG. 10 and FIG. 11.

FIG. 9 illustrates a routine 900 in accordance with one embodiment, for example associated with a method of data segment identification. In block 902, routine 900 generates, by a processor and during a first segmentation run for a first plurality of data segments, a first set of content-based segment identifiers based on unique content-based attributes of the first plurality of data segments. In block 904, routine 900 generates, by a processor and during a second segmentation run for a second plurality of data segments, a second set of content-based segment identifiers based on unique content-based attributes of the second plurality of data segments. In block 906, routine 900 identifies, by the processor, unchanged data segments between the first segmentation run and the second segmentation run by comparing the content-based segment identifiers for the first plurality of data segments with the content-based segment identifiers for the second plurality of data segments. In block 908, routine 900 generates and stores a list of unchanged data segments to omit from incremental training of a machine learning model.

FIG. 10 illustrates a routine 1000 in accordance with one embodiment, for example associated with a method of data tracing in a data segmentation environment. In block 1002, routine 1000 obtains, by a processor and during a first segmentation run, a first plurality of data segments each including unique content-based attributes. In block 1004, routine 1000 generates, by the processor and in relation to the first segmentation run, a content-based segment identifier for each of the first plurality of data segments based on the unique content-based attributes. In block 1006, routine 1000 obtains, by the processor and in relation to a second segmentation run, a second plurality of data segments each including second content-based attributes. In block 1008, routine 1000 generates, by the processor and in relation to the second segmentation run, a content-based segment identifier for each of the second plurality of data segments based on the second content-based attributes. In block 1010, routine 1000 stores, by the processor, modified data segment identifiers associated with a set of modified data segments based on a comparison of the content-based segment identifiers for the first plurality of data segments with the content-based segment identifiers for the second plurality of data segments.

FIG. 11 illustrates a routine 1100 in accordance with one embodiment, for example associated with a method of data segment identifier generation. In block 1102, routine 1100 obtains, by a processor, a plurality of data segments, each of the plurality of data segments including unique content-based attributes. In block 1104, routine 1100 generates, by the processor and for each of the plurality of data segments, a content-based segment identifier based on the unique content-based attributes.

Various aspects and embodiments of the present disclosure are described and illustrated herein.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A system comprising:
a processor; and
a memory storing instructions that, when executed by the processor, configure the system to:
generate, in relation to a first segmentation run for a first plurality of data segments, a first set of content-based segment identifiers based on unique content-based attributes of the first plurality of data segments;
initially train a machine learning model based on the first plurality of data segments;
generate, in relation to a second segmentation run for a second plurality of data segments, a second set of content-based segment identifiers based on second content-based attributes of the second plurality of data segments;
identify a set of modified data segments between the first segmentation run and the second segmentation run by comparing the content-based segment identifiers for the first plurality of data segments with the content-based segment identifiers for the second plurality of data segments; and
incrementally train the machine learning model for only the set of modified data segments.

2. The system of claim 1, wherein the unique content-based attributes comprise a unique sequence of segment key and value combinations.

3. The system of claim 1, wherein the unique content-based attributes comprise a unique sequence of segment key and value pairs.

4. The system of claim 1, wherein the system is further configured to:
generate a first hash of the unique content-based attributes associated with the first set of content-based segment identifiers when generating the first set of content-based segment identifiers; and
generate a second hash of the unique content-based attributes associated with the second set of content-based segment identifiers when generating the second set of content-based segment identifiers.

5. The system of claim 1, wherein each of the first set of content-based segment identifiers and the second set of content-based segment identifiers comprises a universally unique content-based segment identifier.

6. A non-transitory computer-readable storage medium, the computer-readable storage medium including instructions that when executed by a computer, cause the computer to:
generate, in relation to a first segmentation run for a first plurality of data segments, a first set of content-based segment identifiers based on unique content-based attributes of the first plurality of data segments;
initially train a machine learning model based on the first plurality of data segments;
generate, in relation to a second segmentation run for a second plurality of data segments, a second set of content-based segment identifiers based on second content-based attributes of the second plurality of data segments;
identify a set of modified data segments between the first segmentation run and the second segmentation run by comparing the content-based segment identifiers for the first plurality of data segments with the content-based segment identifiers for the second plurality of data segments; and
incrementally train the machine learning model for only the set of modified data segments.

7. The non-transitory computer-readable storage medium of claim 6, wherein the unique content-based attributes comprise a unique sequence of segment key and value combinations.

8. The non-transitory computer-readable storage medium of claim 6, wherein the unique content-based attributes comprise a unique sequence of segment key and value pairs.

9. The non-transitory computer-readable storage medium of claim 6, wherein the computer is further configured to:
generate a first hash of the unique content-based attributes associated with the first set of content-based segment identifiers when generating the first set of content-based segment identifiers; and
generate a second hash of the unique content-based attributes associated with the second set of content-based segment identifiers when generating the second set of content-based segment identifiers.

10. The non-transitory computer-readable storage medium of claim 6, wherein each of the first set of content-based segment identifiers and the second set of content-based segment identifiers comprises a universally unique content-based segment identifier.

11. A method of training a machine learning model in a data segmentation environment including:
generating, by a processor and in relation to a first segmentation run for a first plurality of data segments, a first set of content-based segment identifiers based on unique content-based attributes of the first plurality of data segments;
initially training the machine learning model based on the first plurality of data segments;
generating, by the processor and in relation to a second segmentation run for a second plurality of data segments, a second set of content-based segment identifiers based on second content-based attributes of the second plurality of data segments;
identifying, by the processor, a set of modified data segments between the first segmentation run and the second segmentation run by comparing the first set of content-based segment identifiers for the first plurality of data segments with the second set of content-based segment identifiers for the second plurality of data segments; and
incrementally training the machine learning model for only the set of modified data segments.

12. The method of claim 11, wherein the unique content-based attributes comprise a unique sequence of segment key and value combinations.

13. The method of claim 11, wherein the unique content-based attributes comprise a unique sequence of segment key and value pairs.

14. The method of claim 11, wherein the method further comprises:
generating, by the processor a first hash of the unique content-based attributes associated with the first set of content-based segment identifiers when generating the first set of content-based segment identifiers; and
generating, by the processor, a second hash of the unique content-based attributes associated with the second set of content-based segment identifiers when generating the second set of content-based segment identifiers.

15. The method of claim 11, wherein each of the first set of content-based segment identifiers and the second set of content-based segment identifiers comprises a universally unique content-based segment identifier.
